(19) United States
(12) Patent Application Publication
(10) Pub. No.: US 2004/0052475 A1
(43) Pub. Date: Mar. 18, 2004

(54) Fiber collimator and method of manufacturing the same

(75) Inventors: Jau-Jan Deng, Taipei (TW); I-Lin Chu, Taipei (TW); Shu-Mein Tsan, Taipei (TW)

Correspondence Address: TROXELL LAW OFFICE PLLC, SUITE 1404, 5205 LEESBURG PIKE, FALLS CHURCH, VA, 22041, US

(73) Assignee: E-Pin Optical Industry Co., Ltd.

(21) Appl. No.: 10/245,325

(22) Filed: Sep. 18, 2002

(51) Int. Cl. G02B 6/36; G02B 6/32

(52) U.S. Cl. 385/79; 385/33

(57) ABSTRACT

A fiber collimator includes a holder having a spacer provided therein, an aspherical lens, and a fiber pigtail. The spacer has a design thickness taking a machining tolerance thereof into consideration to be equal to or larger than an effective focal length of the aspherical lens, with a difference thereof no more than 30 μm. The fiber pigtail and the aspherical lens are separately inserted into two ends of the holder to abut against and fix to two end surfaces of the spacer. Since the spacer has a thickness varies with changes in its machining tolerance, a focus-out distance Δd of the fiber tip always randomly falls in a fixed range, for example, from 30 μm≧Δd≧0, and the finished fiber collimator always has an optimal working distance within an enlarged range from 0 to 140 mm. A method for manufacturing the fiber collimator is also described.

### BACKGROUND OF THE INVENTION

The present invention relates to a fiber collimator and a method of manufacturing the same. The fiber collimator includes a holder having a spacer provided therein, an aspherical lens, and a fiber pigtail. The aspherical lens and the fiber pigtail are separately fitly inserted into the holder to abut against and fix to two end surfaces of the spacer. Different machining tolerances of the spacer make finished fiber collimators have different optimal working distances. The finished fiber collimators may be then graded according to the working distances thereof.

In optical communication, it is often necessary to expand and collimate beams transmitted via an optical fiber, and let such expanded and collimated beams pass some functional elements before they are focused and coupled back to another optical fiber for subsequent transmission via the optical fiber. A fiber collimator is an optical element having the above-mentioned function. A fiber collimator system usually includes two mating fiber collimators. When a transmitted beam having a fixed beam divergence angle passes through a collimating lens of a first one of the two fiber collimators to be collimated and then moves across a working distance defined in the system, it is focused and coupled by the other fiber collimator back to anothe optical fiber. Various kinds of functional elements may be provided within the working distance. An optimal working distance for a fiber collimator system is a distance between two fiber collimators that allows a collimated beam between the two fiber collimators to maintain a required collimation while a lowest possible insertion loss is maintained for the system.

FIG. 1 shows a conventional fiber collimator 10 that includes a glass tube 11 having a smooth inner bore, a fiber pigtail 12 having an outer diameter the same as an inner diameter of the glass tube 11 for fixedly mounting in the glass tube 11 to locate an optical fiber 13 therein, and a graded-index lens (GRIN lens) 14 for collimating the beam transmitted via the optical fiber 13 or coupling the collimated beam back to another optical fiber. The glass tube 11 is enclosed with a stainless steel holder 15 to facilitate subsequent bonding, including laser welding, soldering, etc. To reduce the insertion loss of the fiber collimators during assembling of the fiber collimators, it usually needs to conduct a real-time adjustment and calibration of a position of the fiber pigtail 12 relative to the graded-index lens 14, so that an output beam could be best collimated within the working distance. That is, the output beam may have a minimal beam divergence angle and a minimal deflection angle. The above-described conventional fiber collimator 10 using graded-index lens 14, or the method for producing it, such as disclosed in U.S. Pat. No. 6,168,319 B1 entitled System and Method for Aligning Optical Fiber Collimators, has the following disadvantages in the application and the manufacturing process thereof:

1. The graded-index lens requires highly difficult manufacturing techniques and could not be easily molded at reduced manufacturing cost.

2. Once a graded-index lens having a particular length is selected, the working distance for the fiber collimator system using the graded-index lens is determined, too. Thus, in manufacturing a fiber collimator system, it is necessary to decide beforehand the working distance depending on the types of functional elements that are to be included in the system, and then decide the length of the graded-index lens. As a result, various lengths must be prepared for different graded-index lenses to increase a lot of troubles in production management of fiber collimator systems.

3. To reduce the insertion loss of the fiber collimators during assembling of the fiber collimators, it usually needs to conduct a real-time adjustment and calibration of a position of the fiber pigtail 12 relative to the graded-index lens 14, so that the output beam could be best collimated within the working distance. However, each time of optical adjustment and calibration involves alignment and adjustment of freedom of five axes X, Y, Z, θ, and Φ. The calibration is extremely complicate to increase the manufacturing cost of the fiber collimator.

4. For an optical element that requires a long working distance, it is unable to maintain an insertion loss less than 0.15 dB for the graded-index type fiber collimator. Accordingly, the graded-index type fiber collimator has a reduced optical performance and is not suitable for optical elements having a long working distance from, for example, 100 mm to 140 mm, such as many multi-port optical devices, including, for example, optical circulator, optical interleaver, optical switch, etc. Thus, the graded-index type of fiber collimator is not qualified in terms of its performance.

An aspherical lens is functionally similar to the graded-index lens, and is able to convert a beam emitted from a point, such as from a fiber tip, within an effective focal length (EFL) f into a collimated beam. However, when an aspherical lens is directly used to replace the graded-index lens adopted in the conventional graded-index type fiber collimator, there are still many very complicate optical adjusting and calibrating operations involved in the manufacturing process of the fiber collimator. Up to date, there is not any fiber collimator using aspherical lens being found in the market to provide satisfactory performance. It is therefore tried by the inventor to develop an improved fiber collimator to eliminate the drawbacks existed in the conventional fiber collimators.

### SUMMARY OF THE INVENTION

A primary object of the present invention is to provide a fiber collimator, and a method of manufacturing the fiber collimator.

The fiber collimator manufactured in the method of the present invention mainly includes a holder having a spacer provided therein, an aspherical lens, and a fiber pigtail. The spacer has a design thickness T (that is, a length of the spacer measured in an axial direction of the holder) taking a machining tolerance thereof into consideration to be equal to or larger than an effective focal length (EFL) f of the aspherical lens, with a difference between T and f no more than 30 μm. The fiber pigtail and the aspherical lens have an outer diameter the same as an inner diameter of the holder for separately inserting into two ends of the holder to abut against and fix to two end surfaces of the spacer. Since the spacer has a thickness varies with changes in its machining tolerance, a focus-out distance (Δd=d₁−f, wherein d₁ is the actual distance from the fiber tip to the aspherical lens) of the fiber tip always randomly falls in a fixed range from 30 μm≧Δd≧0, and a finished fiber collimator always has an optimal working distance randomly falling in an enlarged range from 0 to 140 mm. The finished fiber collimator is screened and graded according to different working distances, so that users may easily select a desired fiber collimator depending on functional devices to be included in the optical transmission. A fiber collimator system established with the method of the present invention has a larger range of working distance from 0 to 140 mm and may therefore be applied to elements requiring long working distances while an insertion loss lower than 0.15 dB can be maintained for the collimator system to provide an enhanced optical performance. The present invention does not require complicate optical adjustment and calibration procedures and can therefore be manufactured with simplified process and at largely reduced cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a conventional fiber collimator;

FIG. 2 illustrates the optical properties of an aspherical lens;

FIG. 3 is a flowchart showing steps included in the method for manufacturing the fiber collimator of the present invention;

FIG. 4 is an exploded sectional view of a fiber collimator manufactured in the method of the present invention; and

FIG. 5 is an assembled sectional view of the fiber collimator of FIG. 4.

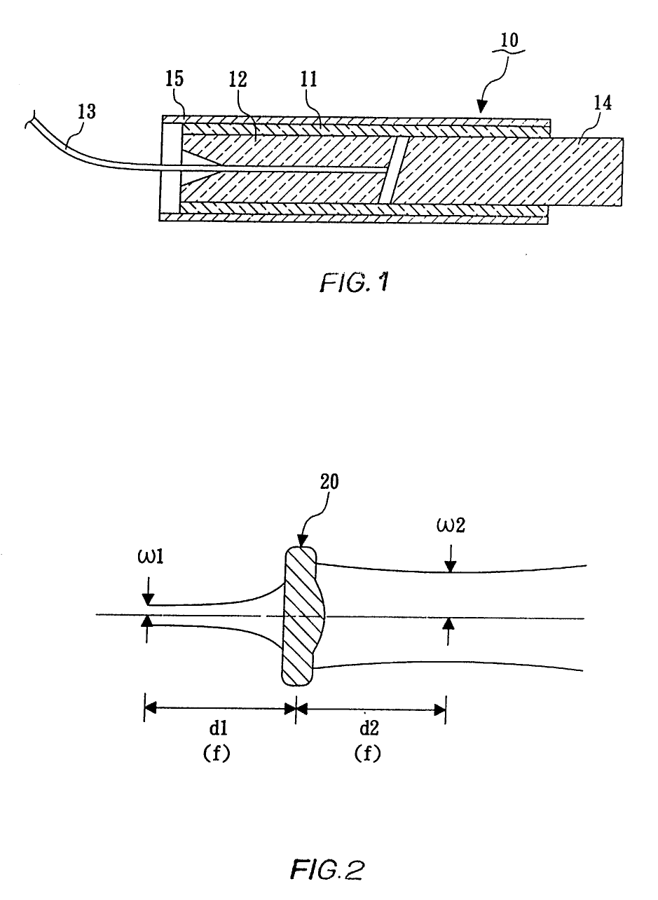

### DETAILED DESCRIPTION OF THE PREFERRED EMBODIMENTS

Please refer to FIG. 2 that shows the optical properties of an aspherical lens 20. The aspherical lens 20 shown in FIG. 2 is an optimized aspherical lens having an extremely small aberration and an effective focal length f. When a Gaussian beam having a beam waist of ω₁ emitted from a fiber tip travels over a length d₁, which is a distance from the fiber tip to the aspherical lens 20, to pass through the aspherical lens 20 and be focused at d₂, an optimal working distance for the current fiber collimator system is 2d₂, and the beam now has a beam waist or a spot radius ω₂. For a single-mode fiber, it is possible to derive a formula to reflect a relation among ω₂ and ω₁, f, Δd (Δd=d₁−f). From the above-mentioned optical properties, it can be known when an aspherical lens is used in place of the graded-index lens, it is possible to analyze various focusing conditions of the beam having passed through the aspherical lens 20 by way of changing the focus-out distance Δd of the fiber tip. The analysis results are shown as below:

Case 1: When d₁=f, there is a Δd=0. In this case, the focus is located at a point away from the lens 20 by a distance of f, the collimated light has a maximal spot radius or spot size and a minimal beam divergence angle, and the optimal working distance is 2f.

Case 2: When d₁>f, there is a Δd>0. That is, the fiber tip is moved toward a left side of FIG. 2. At this point, the focus gradually moves away from the lens 20 to locate beyond the distance f. That is, the optimal working distance gradually increases, the spot size gradually reduces, and the beam divergence angle gradually increases.

Case 3: When d₁>>f, there is a Δd>>0. That is, the fiber tip is moved toward the left side of FIG. 2 to locate beyond a certain distance. At this point, the focus is located at a point between the lens 20 and the distance f, the spot size is very small, and the beam divergence angle is very big.

Case 4: When d₁<f, there is a Δd<0. That is, the fiber tip is moved rightward toward the aspherical lens 20. At this point, the collimated light does not focus but diverges directly, with a virtual focus thereof located in front of the aspherical lens 20. That is, d₂<0. And, there is not an optimal working distance.

By substituting the optical properties of a single-mode fiber for the above formulas, it can be known further that when the focus-out distance Δd (Δd=d₁−f) of the fiber tip is within the range from 5 to 60 μm, the optimal working distance available is within the range from 0 to 150 mm. At this point, the beam divergence angle is always smaller than 0.0025°.

The insertion loss of a fiber collimator system is resulted from misalignment and unmatched spot size between two Gaussian beams output from two collimators. Therefore, in the above-mentioned case 1 to case 3, given that the lens 20 has an aperture quite larger than a spot size of an input Gaussian beam, so long as the working distances of the two fiber collimators are adjusted to the optimal working distance 2d₂, it is possible for the insertion loss of the collimators due to unmatched spot size to close to zero.

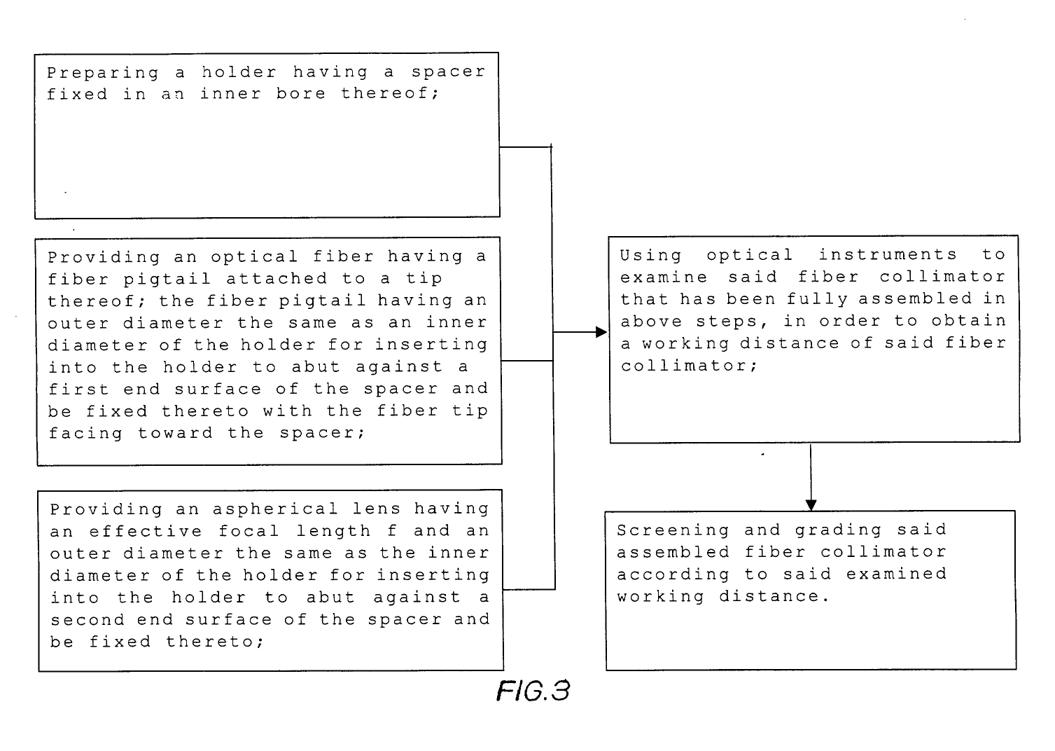

As shown in FIGS. 3, 4 and 5, the present invention is designed according to the above-described principle by using the optical properties of an aspherical lens in a fiber collimator. More particularly, the present invention is designed according to the principle that the optimal working distance 2d₂ of a fiber collimator system can be controlled through effective control of the focus-out distance Δd of the fiber tip.

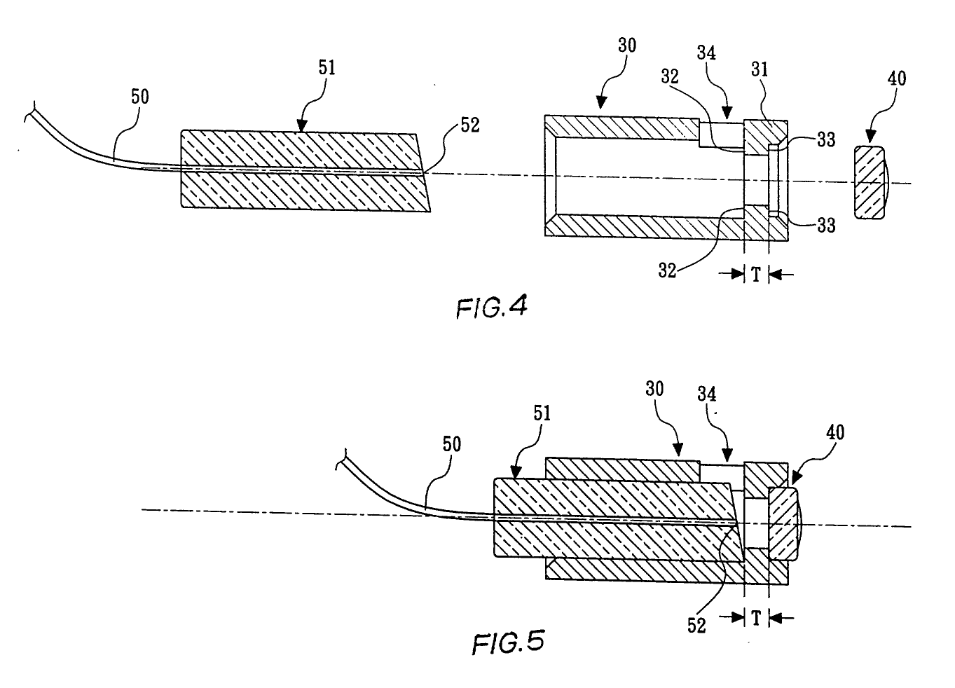

Please refer to FIG. 4. The fiber collimator of the present invention mainly includes an holder 30 having a spacer 31 provided in an inner bore thereof, an aspherical lens 40, and a fiber pigtail 51. The fiber collimator of the present invention is manufactured through the following steps:

Preparing a holder 30 having a spacer 31 fixed in an inner bore thereof; a machining tolerance for the spacer 31 during manufacturing thereof is taken into consideration, so that the spacer 31 has a design thickness T equal to or larger than the effective focal length (EFL) f of an aspherical lens to be used, and a portion of the thickness T that exceeds the EFL f is preferably controlled to be less than 30 μm;

Providing an optical fiber 50 having a fiber pigtail 51 attached to a fiber tip thereof; the fiber pigtail 51 has an outer diameter the same as an inner diameter of the holder 30 for inserting into the holder 30 to abut against a first end surface 32 of the spacer 31 and be fixed thereto;

Providing an aspherical lens 40 having an outer diameter the same as the inner diameter of the holder 30 for inserting into the holder 30 to abut against a second end surface 33 of the spacer 31 and be fixed thereto; and

Examining the effective focal length f of the aspherical lens using light wavelength.

In the fiber collimator obtained from the above steps, since the thickness T of the spacer 31 varies with changes in the machining tolerance of the spacer 31, it is possible for the focus-out distance (Δd=d₁−f, wherein d₁ is the distance from the fiber tip 52 to the aspherical lens 40) of the fiber tip 52 to be always controlled within a fixed range of 30 μm≧Δd≧0. This enables control of the optimal working distance for each fiber collimator to be always within the range from 0 mm to 140 mm. Therefore, different working distances for all finished fiber collimators can be detected using appropriate optical instruments. The range of working distance from 0 mm to 140 mm may then divided into several grades with, for example, every 20 mm as a grade, and the produced fiber collimators may be screened and graded based on these grades to be easily selected for use with various optical elements requiring different working distances.

The aspherical lens 40 may be a molding aspherical glass lens of approximating to zero aberration. That is, the aberration of the aspherical lens 40 approximates to zero (<0.025λ at λ=0.6328 μm) after being compensated with an aspherical high-order coefficient. The holder 30 may be made of a stainless steel material or a glass material, and the spacer 31 may be integrally formed with the holder 30. Since the thickness T of the spacer 31 is controlled to be equal to or larger than the EFL f of the aspherical lens 40, and the portion of the thickness T larger-than the EFL f is preferable smaller than 30 μm, the value of T may be designed to be T=(f+15 μm)±15 μm, given the machining tolerance is within the range from 5 to 15 μm.

The fiber pigtail 51 and the aspherical lens 40 may be fixed to the first and the second end surfaces 32, 33, respectively, of the spacer 31 with, for example, UV glue. Moreover, the holder 30 is provided at a lengthwise surface within the length of the spacer 31 with an air vent 34 of predetermined dimensions, so that the holder 30 is maintained at an internal pressure similar to an ambient pressure to provide an enhanced reliability of environmental factors.

In brief, in the fiber collimator system of the present invention, the working distance may have an enlarged range from 0 mm to 140 mm through effective control of the spacer thickness T, and the insertion loss may be maintained at less than 0.15 dB. Moreover, the present invention does not require optical adjustment and calibration in the process of actual assembling thereof. It needs only to be screened and graded based on different working distances resulted from different machining tolerances of the spacer when the present invention is subjected to examination of optical beam profile at a rear stage of the production. Therefore, the present invention may be manufactured at largely reduced cost without the need of conducting technically difficult and time and labor consuming optical adjustment and calibration. On the other hand, the present invention provides upgraded optical performance and may be applied to optical elements requiring long working distance, such as multi-port optical devices, including optical circulator, optical interleaver, optical switch, etc.

The present invention provides at least the following advantages:

1. It does not require complicate optical adjusting and calibrating procedures. In view that changes in the optimal working distance may be obtained from different machining tolerances, the present invention needs only to be tested for its optical performance, including the insertion loss, the reflection loss, and the optimal working distance, after a passive alignment procedure thereof.

2. In order to obtain the optimal optical properties at different working distances, including the minimal beam divergence angle, the lowest insertion loss, the minimal deflection angle, and the lowest reflected light, it is necessary in the conventional graded-index lens technique to conduct real-time adjustment and calibration of the position of the fiber pigtail relative to the graded-index lens. However, in the present invention that uses an aspherical lens, such complicate adjustment and calibration are not necessary because an error between the relative position of the fiber pigtail and the aspherical lens results in only changes in the optimal working distance, but not any increase of non-compensated insertion loss.

3. The present invention employs the property of machining and does not require real-time adjustment and calibration to manufacture fiber collimators of different working distances.

The present invention has been described with a preferred embodiment thereof and it is understood that many changes and modifications in the described embodiment can be carried out without departing from the scope and the spirit of the invention as defined by the appended claims.

What is claimed is:

1. A fiber collimator, comprising a holder, an aspherical lens, and a fiber pigtail;
said holder being provided in an inner bore with a spacer that has a first and a second end surface;
said spacer having a design thickness T taking a machining tolerance into consideration to be equal to or larger than an effective focal length f of said aspherical lens;
said fiber pigtail having an optical fiber provided therein, said fiber pigtail having an outer diameter the same as an inner diameter of said holder for inserting into said holder to abut against said first end surface of said spacer and be fixed thereto, such that a fiber tip of said optical fiber provided in said fiber pigtail faces toward said spacer; and
said aspherical lens having an outer diameter the same as said inner diameter of said holder for inserting into said holder to abut against said second end surface of said spacer and be fixed thereto, and said effective focal length f of said aspherical lens being detectable using light wavelength; and
said spacer in said holder of said fiber collimator that has been fully assembled having a length varying with changes in said machining tolerance thereof, such that a focus-out distance Δd of said fiber tip can be controlled within a fixed range, and an optimal working distance of said fiber collimator can be controlled within an enlarged range to enable manufacturing of said fiber collimator with simplified processes and expanded application of said fiber collimator.

2. The fiber collimator as claimed in claim 1, wherein said machining tolerance being taken into consideration is within a range from 5 to 15 μm, and wherein said design thickness T of said spacer is T=(f+15 μm)±15 μm.

3. The fiber collimator as claimed in claim 1, wherein said focus-out distance Δd of said fiber tip is controlled to be within the range of 30 μm≧Δd≧0.

4. The fiber collimator as claimed in claim 1, wherein said optimal working distance for said fiber collimator is controlled to be within the range from 0 mm to 140 mm while an insertion loss for said fiber collimator is maintained to be lower than 0.15 dB.

5. The fiber collimator as claimed in claim 1, wherein said aspherical lens is a molding aspherical glass lens having an almost zero aberration.

6. The fiber collimator as claimed in claim 1, wherein said holder is made of a stainless steel material.

7. The fiber collimator as claimed in claim 1, wherein said holder is made of a glass material.

8. The fiber collimator as claimed in claim 1, wherein said spacer is integrally formed with said holder.

9. The fiber collimator as claimed in claim 1, wherein said fiber pigtail and said aspherical lens are fixed to said first and said second end surface, respectively, of said spacer by means of UV glue.

10. The fiber collimator as claimed in claim 1, wherein said holder is provided within the length of said spacer with an air vent to maintain an inner pressure of said holder the same as an ambient pressure to enable reliable environmental factors.

11. A method of manufacturing a fiber collimator, said fiber collimator including a holder having a spacer provided in an inner bore thereof, an aspherical lens, and an optical fiber pigtail, comprising the following steps:
Preparing a holder having a spacer fixed in an inner bore thereof;
Providing an optical fiber having a fiber pigtail attached to a tip thereof; said fiber pigtail having an outer diameter the same as an inner diameter of said holder for inserting into said holder to abut against a first end surface of said spacer and be fixed thereto with said fiber tip facing toward said spacer;
Providing an aspherical lens having an effective focal length f and an outer diameter the same as said inner diameter of said holder for inserting into said holder to abut against a second end surface of said spacer and be fixed thereto; and
Using optical instruments to examine said fiber collimator that has been fully assembled in above steps, in order to obtain a working distance of said fiber collimator; and
Screening and grading said assembled fiber collimator according to said examined working distance.

12. The method of manufacturing a fiber collimator as claimed in claim 11, wherein said spacer in said holder has a design thickness T that takes a machining tolerance of said spacer into consideration so as to be equal to or larger than said effective focal length f of said aspherical lens.

13. The method of manufacturing a fiber collimator as claimed in claim 11, wherein said machining tolerance being taken into consideration is within a range from 5 to 15 μm, and wherein said design thickness T of said spacer is T=(f+15 μm)±15 μm.

14. The method of manufacturing a fiber collimator as claimed in claim 11, wherein said fiber tip has a focus-out distance Δd being controlled to be within the range of 30 μm≧Δd≧0.

15. The method of manufacturing a fiber collimator as claimed in claim 11, wherein said fiber collimator has an optimal working distance being controlled to be within the range from 0 mm to 140 mm.

16. The method of manufacturing a fiber collimator as claimed in claim 12, wherein said range of said working distance from 0 mm to 140 mm is divided into several grades with each 20 mm as a grade.
